(19) United States
(12) Patent Application Publication
(10) Pub. No.: US 2004/0032742 A1
(43) Pub. Date: Feb. 19, 2004

(54) Luminaire with articulated and expandable joints

(76) Inventors: Norbert H.W. Dannatt, Colorado Springs, CO (US); James Ray Lynn, Colorado Springs, CO (US)

Correspondence Address: Gould & Whitley, Attorneys at Law, Suite 101, 1665 Briargate Boulevard, Colorado Springs, CO, 80920, US

(21) Appl. No.: 10/222,227

(22) Filed: Aug. 15, 2002

(51) Int. Cl. F21S 8/08

(52) U.S. Cl. 362/419; 362/418; 362/393

(57) ABSTRACT

A luminaire supports different types of lamps or light bulbs in a strip which is adjustable as to length and as to angles or curvature between adjacent lamps. The luminaire consists of multiple support members, which can be fashioned as a variety of shapes and sizes. Each support member supports a lamp socket, and may additionally support a ballast or other equipment. A rigid conduit inserted into holes in the end of adjacent support members provides a connection between those adjacent support members. Additionally, the conduit provides a passageway for wires or other conductors running between support members. The rigidity of each conduit provides protection for such conductors. A restraining mechanism limits the movement of the rigid conduit with respect to each support member into which each end of the conduit is inserted, preventing the conduit from withdrawing from a support member and limiting movement of the conduit into the support mechanism. However, such restraining mechanism also provides a means of adjusting the length between adjacent support members, and thus the length of the luminaire as a whole. The restraining mechanism can simply consist of multiple protrusions extending from the exterior of the conduit, some internal to the support members into which the conduit is inserted and some external to that support member.

### 1.0 BACKGROUND OF THE INVENTION

1.1 Technical Field

This invention pertains to a luminaire or lighting fixture suitable for supporting a variety of different types of lamps, which luminaire has articulated and expandable joints so that the lamps can be arranged in a variety of shapes and configurations.

1.2 Background Art

Luminaires are used in many contexts to provide an extended band of illumination for displays, walkways, shelving, cove, and other areas. Ideally, such luminaires should be sufficiently flexible to allow individual lamps or light bulbs to be placed in positions which are in a variety of different planes. For example, it may be advantageous to have one section of a luminaire follow a straight line, while another segment forms a line which is at an acute, right, or obtuse angle to the first section, to illuminate a corner of a display. Similarly, it is beneficial to have the flexibility to arrange lamps along a curve. Furthermore, it may be desirable to utilize a single ballast or transformer for multiple lamps in the lighting fixture, while still allowing those multiple lamps to exist in different planes relative to each other. A rigid conduit for any connecting wires may provide the most protection for those wires. Flexibility in lighting arrangements may be advantageously achieved by permitting the conduit between adjacent lamp supports to have a variable length.

Lighting fixtures offering some flexibility in the placement of lamps are known in the prior art. For example, a lighting fixture described in U.S. Pat. No. 5,422,802 to Lin is designed to allow flexible placement of a single bulb with respect to a stationery lamp base. While useful for its intended purpose, the Lin fixture does not address the issue of placing multiple lamps or bulbs in a variety of positions with respect to each other.

A lighting fixture taught in U.S. Pat. No. 5,448,460 to Belfer et al. does include multiple lamps. The particular connection assembly between each support member in the Belfer fixture permits each lamp to pivot within a plane with respect to an adjacent support member. A greater degree of flexibility would be useful, and is achieved in a lighting fixture described in U.S. Pat. No. 5,436,816 to Nagano. However, any connecting wires must pass through a flexible passageway, which may not provide adequate protection for those connecting wires. Furthermore, the Nagano passageway has a fixed length, requiring adjacent support members to be spaced at inflexible intervals.

A luminaire suitable for lighting lengths of passageways or displays is needed, which can be articulated to permit individual lamps to be supported at a variety of angles and rotations with respect to each other, provides for a rigid passageway for connecting wires, and permits flexibility in the distance between adjacent lamps.

### 2. DISCLOSURE OF THE INVENTION

### 2.1 SUMMARY OF THE INVENTION

An object of this invention is to provide a luminaire which can be arranged in multiple lengths and angles to provide a strip of lamps in a variety of configurations.

Another object of this invention is to provide such a luminaire which has a rigid conduit to protect any connecting wires.

Yet another object of this invention is to provide such a luminaire which will support a variety of types of bulbs and lamps.

The luminaire or lighting fixture claimed herein consists of multiple support members, each of which has a mounting surface suitable for supporting a lamp socket or lamp holder. The term lamp socket will be used herein to refer to sockets suitable for receiving incandescent bulbs of many different sizes and lamp holders suitable for receiving a variety of fluorescent lamps. In this manner, the luminaire claimed herein is capable of supporting lamps, bulbs, or lights of many different types. Each support member is also capable of supporting additional mechanisms such as a ballast or transformer. If a support member is shaped as a rectangular prism, an exterior surface of the prism can be used to support one or more lamp sockets, while a ballast or transformer may be effectively hidden from view by placement inside the prism. However, other shapes may be advantageously utilized for each support member.

Adjacent support members are connected by a rigid conduit which is inserted into each support member through an opening in the end of each support member. Such conduit can be of many shapes and sizes. For example, if the opening in the end of each support member is a circle, the rigid conduit could be cylindrical in shape. The conduit serves multiple purposes. First, the conduit provides a means of connecting adjacent support members. Second, the conduit provides a passageway through which wires can pass to provide electrical current to individual lamp sockets, and possibly to connect a lamp socket on one support member to a ballast or transformer supported by a different support member. Indeed, connecting wires may pass through more than one conduit to enable a ballast or transformer on one support member to be connected to a lamp socket on a support member which is not even adjacent to the ballast-supporting support member. Thirdly, the conduit provides a mechanism which enables the luminaire to be lengthened or shortened to place individual support members at different distances with respect to each other. This expandability is useful when individual support members are being placed in an area where particular placement of support members is dictated by irregularly spaced points of attachment.

Significantly, the conduit is not attached to a support member. Instead, the conduit is inserted through an opening formed in each of two adjacent support members. Because the conduit is not actually connected to a support member, it can move in an infinite number of planes relative to the adjacent support member, resulting in an articulated luminaire.

A restraining mechanism may be advantageously utilized to limit the movement of the conduit into and out of each support member. The conduit may be prevented from moving into a support member by the presence of blocking members within the support member, such as a transformer, ballast, or partial wall erected to block the conduit's entry into the support member. Alternatively, the restraining mechanism may simply consist of some sort of protrusion, such as a bump, nail, rivet, peg, or pin, on the exterior of the conduit. Typically, each conduit would have at least two such protrusions, located near opposite ends of the conduit. When the conduit is inserted in the openings of adjacent support members, those two internal protrusions would extend outward from the conduit inside each support member, restraining the conduit from moving out of each support member.

A single external protrusion or pair of external protrusions may advantageously be utilized as a part of the restraining mechanism. These external protrusions usefully extend outwardly from the conduit outside the support members, when the conduit is inserted in adjacent support members. Each external protrusion prevents the portion of the conduit opposite a support member from the external protrusion from moving into the opening of that support member. If components such as a ballast or transformer might be harmed by the conduit moving into such components, such external protrusion should be located on the conduit in a manner which prevents the conduit from moving so far into the support member that the component is touched by the conduit. It is advantageous, however, to provide significant distance between the internal protrusion and external protrusion on each end of a conduit, as such distance provides flexibility in the distance between adjacent support members. In short, with this particular restraining mechanism, the conduit has a limited ability to slide into and out of each support member.

The novel features that are considered characteristic of the invention are set forth with particularity in the claims. The invention itself, both as to its construction and its method of operation, together with additional objects and advantages thereof, will best be understood from the description of specific embodiments which follows, when read in conjunction with the accompanying drawings.

### 2.2 BRIEF DESCRIPTION OF THE DRAWINGS

FIG. 1 is a perspective view of a luminaire according to the present invention.

FIG. 2 is a perspective view of a portion of a conduit and a portion of a support member of a luminaire according to the present invention.

FIG. 3 is a front view of a support member of a luminaire according to the present invention.

### 2.3 DETAILED DESCRIPTION OF THE PREFERRED EMBODIMENT

The present invention concerns an articulated, expandable luminaire suitable for supporting multiple light sockets in a configuration which is adjustable as to angles or rotations between lamp sockets and length. In the following description, numerous specific details are set forth in order to provide a thorough understanding of the present invention. It will be obvious, however, to one skilled in the art that the present invention may be practiced without these specific details. Some well-known methods and structures have not been set forth in order not to unnecessarily obscure the description of the present invention.

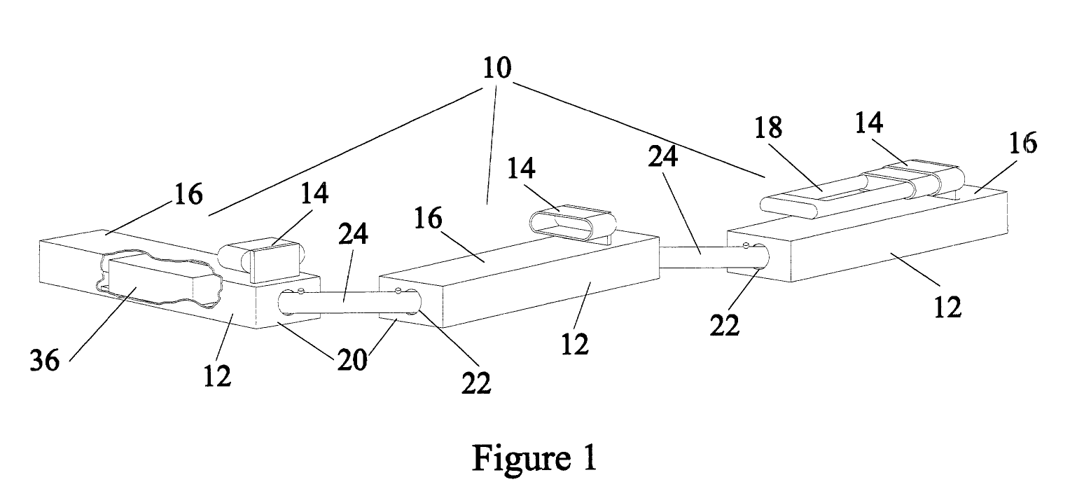

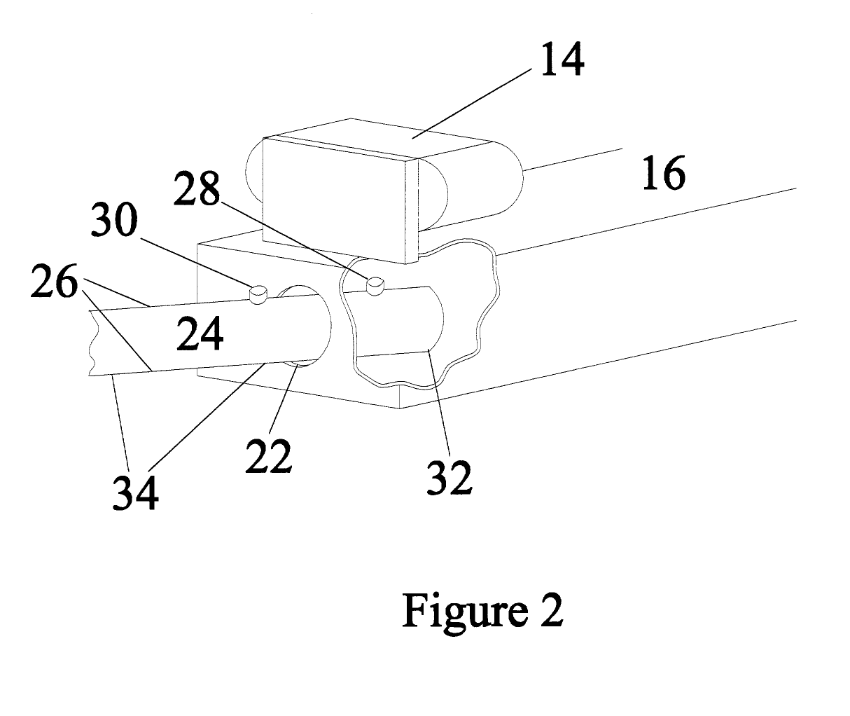

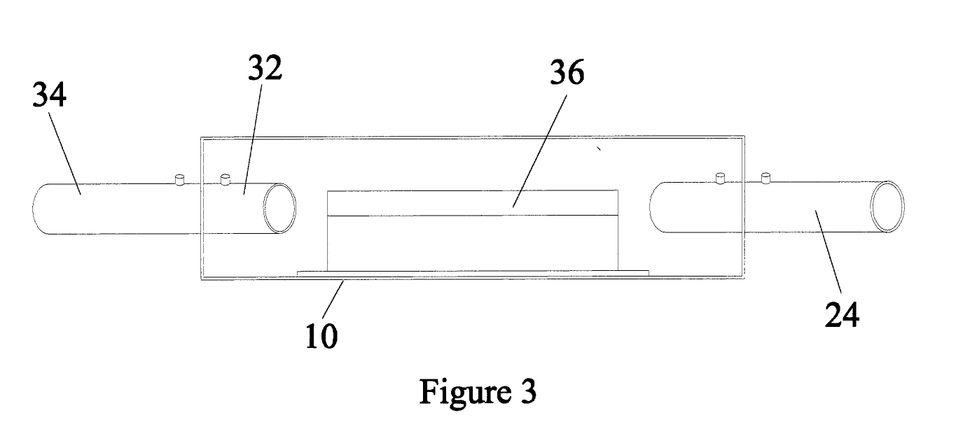

As can be seen in FIG. 1, the luminaire 10 claimed herein includes multiple support members 12 connected together at a variety of different angles by conduits 24. Each conduit 24 consists of a rigid, hollow passageway suitable for holding and protecting wires or other conductors (not shown). The support members 12 and conduits 24 can be made of a variety of different materials, such as aluminum, plastic, steel, or rubber. It is possible to utilize support members 12 of many different shapes and sizes. A rectangular prism, as shown in FIGS. 2 and 3, is an especially advantageous shape for each support member 12, as there are multiple external flat surfaces 16 suitable for supporting lamp sockets 14, while a ballast or transformer 36, or other equipment may be housed within the support member 12. Other shapes may be particularly useful for the support members 12 depending on the location into which the luminaire 10 is to be placed.

Different types of lamp sockets 14 may be used, to accommodate a variety of light bulbs or fluorescent lamps 18, all of which are called light bulbs herein.

An opening 22 is formed in each end 20 of all support members 12 which are interior to the luminaire 10. It is possible to form an opening 22 in only one end 20 of the support members 12 on the end of the luminaire 10, as there is a support member 12 adjacent to only one end 20 of that final support member 12. The size and shape of the opening 22 is determined by the size and shape of the conduit 24. Any size opening 22 is acceptable which permits the conduit 24 to move easily in relation to the opening 22. Thus, the perimeter 26 of the conduit must be smaller than the size of the opening 22, as best shown in FIG. 2. A cylindrical conduit 24 and circular opening 22 provides significant flexibility in movement of one support member 12 with respect to an adjacent support member 12.

The luminaire 10 can be made most economically by limiting the number of hardware components 36 such as ballasts and transformers utilized for the lamps 18. Thus, a ballast 36 is ideally located in only some of the support members 12. Conductors (not shown) passing through the conduits 24 connect a single ballast 36 to multiple lamp sockets 14. By using a rigid conduit 24, these conductors 28 are protected from damage by outside forces.

The novel restraining means used to limit the movement of the conduit 24 into and out of the support members 12 provides flexibility in the placement of adjacent support members 12, both with respect to the angle or curvature between the planes in which those adjacent support members 12 reside, and in terms of the distance between those adjacent support members 12. Flexibility is achieved in part because each conduit 24 is not attached to a support member 12, allowing each conduit 24 to move in numerous positions with respect to an adjacent support member 12. Movement of each conduit 24 can be restrained in a number of ways, such as by the use of protrusions 28,30 strategically placed on the conduit 24. Protrusions 28, 30 can be formed as a bump on the conduit 24, made of the same material as the conduit 24, or as an inserted pin, nail, rivet, peg, or similar restraining mechanism.

As shown in FIGS. 2 and 3, a pair of internal protrusions 28 may be placed on opposite ends of the conduit 24 in such a manner that when the conduit 24 is inserted into the openings 22 of adjacent support members 12, the internal protrusions 28 extend outward from the conduit 24 so that the conduit 24 and internal protrusion 28 are too large to fit through the opening 22. Thus, the internal protrusions 28 prevent the conduit 24 from withdrawing from the support member 12. The segment 32 of the conduit 24 which lies between the internal protrusion 28 and the end of the conduit 24 closest to that protrusion 28 remains inside the support member 12, while the support member 12 can still rotate freely around the conduit 24, and move in different planes with respect to the conduit 24.

Similarly, one or more external protrusions 30 can be utilized to limit the movement of the conduit 24 into the support member 12. This is particularly useful if a ballast 36 or other mechanism is placed in the support member 12, as that ballast 36 is protected from the conduit 24 by an external protrusion 30. The external protrusion 30 extends from the exterior of the conduit 24 so that the conduit 24 cannot move further inside the opening 22, preventing that segment 34 of the conduit 24 which is opposite the support member 12 from the external protrusion 30 from moving into the support member 12. Nevertheless, neither the external protrusions 30 nor the internal protrusions 28 restrict the movement of adjacent support members 12 with respect to each other or with respect to the conduit 24 connecting them, so adjacent support members 12 are moveable relative to each other in an infinite number of planes.

The novel restraining means claimed herein also permits flexibility in the distance between adjacent support members 12. Adjacent support members 12 can be placed at a maximum distance when the adjacent openings 22 of each support member 12 are in contact with each internal protrusion 28. Similarly, adjacent support members 12 can be placed at a minimum distance with respect to each other when the adjacent openings 22 of each support member 12 are in contact with each external protrusion 30. Thus, if a significant distance is provided between adjacent internal protrusions 28 and external protrusions 30, adjacent support members 12 can be placed in a variety of distances from each other. This results in lengthening or shortening the overall length of the entire luminaire 10.

The novel luminaire has been described in detail with particular reference to preferred embodiments thereof. As will be apparent to those skilled in the art in the light of the accompanying disclosure, many substitutions, modifications, and variations are possible in the practice of the invention without departing from the spirit and scope of the invention.

We claim:

1. A luminaire, comprising:
a. a plurality of support members, each having a mounting surface for receiving a lamp socket and at least one conduit-receiving opening in an end thereof,
b. at least one lamp socket for receiving a light bulb mounted on said mounting surface,
c. a rigid conduit with an exterior perimeter smaller than said conduit-receiving opening, so that opposite ends of said conduit are insertible into conduit-receiving openings in adjacent support members, and
d. restraining means for limiting movement of said conduit into and out of each support member, in a manner which permits adjustment of the distance between adjacent support members.

2. A luminaire according to claim 1, wherein said restraining means further comprises:
a. internal protrusion extending outward from conduit inside support member, preventing conduit from withdrawing from conduit-receiving opening in support member,
b. external protrusion extending outward from conduit outside support member, limiting movement of conduit into support member through conduit-receiving opening.

3. A luminaire according to claim 1, wherein said plurality of support members being movable relative to each other in an infinite number of planes.

4. A luminaire according to claim 1, wherein at least one said support member comprises a prism.

5. A luminaire according to claim 1, wherein at least one said support member comprises a rectangular prism.

6. A luminaire according to claim 1, wherein said conduit-receiving opening is circular and said conduit comprises a cylinder.

7. A luminaire according to claim 1, wherein at least one support member supports a ballast.

8. A luminaire according to claim 1, wherein at least one support member supports a transformer.

9. A luminaire according to claim 7, wherein a lamp socket supported by a first support ember is connected to a ballast supported by a second support member by a conductor connected at one end to said ballast, connected at another end to said lamp socket, and passing through at least one rigid conduit connecting said first support member and said second support member.
